(19) United States
(12) Patent Application Publication
(10) Pub. No.: US 2004/0117728 A1
(43) Pub. Date: Jun. 17, 2004

(54) Systems and methods for customizing books

(76) Inventor: Paul W. Gromer, Concord, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/720,814

(22) Filed: Nov. 24, 2003

Related U.S. Application Data
(60) Provisional application No. 60/428,516, filed on Nov. 22, 2002.

(51) Int. Cl. G06F 15/00

(52) U.S. Cl. 715/500

(57) ABSTRACT

Systems and methods for customizing books that include illustrations and associated words describing the illustrations are described. One or more of the illustrations includes one or more drawings of one or more characters. In one embodiment, a method of customizing a book includes providing one or more features related to a character included in the book and associated with selectable options. The book can be customized based on associating one or more of the drawings of the one or more characters with one or more of a selectable character name, a selectable character appearance, a pronoun consistent with a selectable character gender, and a possessive adjective consistent with the selected character gender.

### CLAIM OF PRIORITY

This application claims priority to U.S. Provisional Patent Application Serial No. 60/428,516 filed on Nov. 22, 2002, the contents of which application are expressly incorporated by reference herein in their entirety.

### COPYRIGHT NOTICE

The present application includes material that is subject to copyright protection. The copyright owner does not object to the facsimile reproduction of the application by any person as the application appears in the records of the U.S. Patent and Trademark Office, but otherwise reserves all rights in the copyright.

### BACKGROUND

Encouraging a child to read can be a challenging task that involves finding books associated with a reading level suitable for the child and subject matter of interest to the child. A child's book can include illustrations and associated words that describe the illustrations, in which the illustrations can include drawings of characters.

### SUMMARY

Systems and methods for customizing books that include illustrations and associated words describing the illustrations are disclosed. One or more of the illustrations includes one or more drawings of one or more characters. The disclosed systems and methods can be used to customize a variety of books, such as, but not limited to, children's books.

In some embodiments, methods of customizing a book can include receiving a request to customize the book and, based on the request, providing one or more features related to one or more characters included in the book and associated with options for selection. The features can include names of characters, genders of characters, and appearances of characters. The gender options can include male and female. The appearance options can be based on the appearance of humans and non-humans and can include male and female appearance options, ethnicity-based appearance options (such as, but not limited to, African, Caucasian, Hispanic, and Asian appearance options), partial-body-based appearance options (such as, but not limited to, physiognomies and torsos), and whole-body-based appearance options. The book can be customized based on associating the drawings of the characters with selected character names, selected character appearances/depictions, pronouns consistent with selected character genders, and possessive adjectives consistent with the selected character genders.

In some embodiments, the methods can further include providing one or more book features associated with one or more book options including book reading levels and book titles for selection.

In some embodiments, the methods can further include providing an author name feature related to the name of the author of the customized book and associated with one or more name options for selection.

In some embodiments, the methods can further include providing a preview that includes one or more pages of the customized book, where such preview may not include all pages of the customized book. In one aspect, the illustrations of the customized book can include outlines for coloring.

In some embodiments, the methods can further include providing an option to change one or more of a selected appearance option, a selected name option, and a selected gender option.

Systems and methods for generating and redeeming gift identifiers are also described. A gift can be requested by an entity (e.g., a “requesting entity”) via one or more servers, referred to as a gift server, where the gift request can be associated with a gift identifier and thereafter associated with a: gift value (e.g., dollar amount, unit(s) of purchase (e.g., a number/fraction of customizable books), etc.), identification information of the entity requesting the gift amount and/or gift identifier (e.g., name, account number, login name, social security number, etc.), contact information of the requesting entity (e.g., email address, postal address, telephone number, pager number, etc.), identification information of the gift recipient/receiving entity (e.g., name, account number, login name, social security number, etc.), and contact information of the gift recipient (e.g., email address, postal address, telephone number, pager number, etc.). Generating a gift identifier can include receiving a payment from a requesting entity, and using the contact information associated with the gift identifier and the gift recipient to notify the gift recipient (e.g., using contact information) of a gift. In one embodiment, the gift recipient may not know the gift value until the gift recipient provides the gift identifier to the gift server, for example, by establishing an account and/or otherwise being authorized by the gift server, and providing the gift identifier. In one embodiment, gift identifiers can be generated based on a data compression scheme and/or a data encryption scheme.

Accordingly, in some embodiments, redeeming gift a gift and/or gift identifier can include receiving a gift identifier from a client (e.g., gift server as provided herein), providing to the client an option to provide a message to the entity who requested the gift certificate, identifying the entity who requested the gift certificate associated with the gift identifier based on receiving a selection of the option, and providing the message to the requesting entity. In some embodiments, the communication of the message to the requesting entity can be performed such that the gift recipient is unaware of the identity and/or contact information associated with the requesting entity. Accordingly, the disclosed methods and systems allow for message creation by the gift recipient, based on a gift identifier, and delivery thereby of the message to the entity requesting the gift, where such entity requesting the gift (and contact information associated therewith) is also associated with the gift identifier, such that the identity and the contact information of the requesting entity is unknown to the gift recipient.

In one embodiment, a requesting entity may establish a gift by associating the gift with a username, where the username is also associated with the gift recipient identity and contact information of the gift recipient. In such an embodiment, the identity of the gift recipient (other than username) and contact information of the gift recipient may be unknown to the requesting entity.

As provided herein, the disclosed methods and systems can provide gift generation, gift delivery, and associated gift messaging (e.g., notification of gift to gift recipient, acknowledgement of gift to requesting entity) without revealing the identity and/or the contact information of the respective entities (e.g., requesting entity, gift recipient), and variations thereof.

In one embodiment, the disclosed methods and systems can provide two options for acknowledgement messaging, including a first option to transmit a pre-determined message, and a second option to transmit a customized message. The pre-determined message can express gratitude to the entity who requested the gift identifier associated with the gift certificate. The messages can include one or more video components (e.g., text and/or graphics) and/or one or more audio components (e.g., sound, such as speech and music).

The methods and systems can thus, based on a database that can associate gift identifiers, gift values, gift recipient/contact information, requesting entities/contact information, identify the requesting entity associated with the received gift identifier based on comparing the received gift identifier with one or more previously stored gift identifiers, in which each of the previously stored gift identifiers is associated with a gift certificate and data identifying the entity who requested the gift certificate.

Processor programs for customizing books and redeeming gift identifiers are also described. The processor programs are stored on processor-readable mediums and, in embodiments, include instructions to cause a processor to execute features of the previously-described methods.

These and other features of the systems and methods described herein can be more fully understood by referring to the following detailed description and accompanying drawings.

### BRIEF DESCRIPTION OF THE DRAWINGS

FIG. 1 schematically illustrates an exemplary system for customizing a book;

FIGS. 2A-2K illustrate exemplary displays of graphical user interfaces that facilitate customization of a book;

FIG. 3 schematically illustrates an embodiment of a method for customizing a book;

FIGS. 4A-4F illustrate exemplary customized books;

FIG. 5 schematically illustrates an embodiment of a method for generating a gift identifier based on a request for a gift certificate; and,

FIG. 6 schematically illustrates an embodiment of a method for redeeming a generated gift identifier for purchase of a product.

### DETAILED DESCRIPTION

Illustrative embodiments will now be described to provide an overall understanding of the disclosed systems and methods. One or more examples of the illustrative embodiments are shown in the drawings. Those of ordinary skill in the art will understand that the disclosed systems and methods can be adapted and modified to provide systems and methods for other applications, and that other additions and modifications can be made to the disclosed systems and methods without departing from the scope of the present disclosure. For example, features of the illustrative embodiments can be combined, separated, interchanged, and/or rearranged to generate other embodiments. Such modifications and variations are intended to be included within the scope of the present disclosure.

The disclosed systems and methods relate to customizing a book that includes one or more illustrations and associated words describing the illustrations, in which one or more of the illustrations includes drawings of one or more characters. As provided herein, a “book” can include an electronic book that can be customized, where as provided herein, such electronic book can be provided to appropriate devices to cause such electronic book to be converted to a non-electronic medium such as, but not limited to, paper. Generally, a client device in communications with a server device, can communicate selections of one or more features of a book to be customized, such as a reading level and a title of the book, and one or more features of a character, such as a name, a gender, and an appearance of the character. A book having the reading level and title selected by the client communications can be customized based on associating one or more drawings of a character with the name, gender, and appearance selected by the client communications. For example, the book can be customized based on associating the drawings of a character with words that include one or more of the selected name of the character, a pronoun consistent with the selected gender of the character, and a possessive adjective consistent with the selected gender of the character.

As provided herein, references to a “client” and/or “server” can be understood to be references to communications emanating therefrom as is known in the art, where such communications can be based on or otherwise initiated using a variety of input devices (keyboard, speech, stylus, mouse, script, etc.) that may generally be understood to be initiated by a user or another controlling such input device. Further, a client and server can be understood herein to be one or more microprocessor-controlled devices, where such device(s) act in a client-server model, where the client and server may reside on the same microprocessor-controlled device, and where based on perspective, the client can be a server, and vice-versa, and accordingly, references to client and/or server are merely for differentiation of the two communicating devices and/or sets of software instructions.

The disclosed systems and methods also relate to generating gifts/gift certificates that can be associated with gift identifiers based on requests for gifts/gift certificates, and also, redeeming the generated gifts for purchases of products using the gift identifiers. Generally, based on receiving requests for gifts/gift certificates, the disclosed systems and methods generate gift identifiers and associate the gift identifiers with the gift certificates and data identifying the entities who request the gift certificates (“requesting entities”) and the entities who receive the gift certificates (“receiving entities”), such as the names and/or the contact information of the requesting and receiving entities. The disclosed systems and methods store the gift identifiers and their associated information in a memory such as a database. Based on receiving a gift identifier, the disclosed systems and methods provide an option to the redeeming/receiving entity to transmit a message to the requesting entity associated with the gift identifier. The message can include a pre-determined message that expresses gratitude, or a customized message. The disclosed systems and methods can provide the message option and transmit the message without revealing to the redeeming entity the name and/or the contact information of the entity who requested the gift certificate associated with the gift identifier. In some embodiments, only a requesting identity's “user name” may be revealed to the receiving entity, and in some embodiments, only a receiving entity's “user name” may be revealed to the requesting entity.

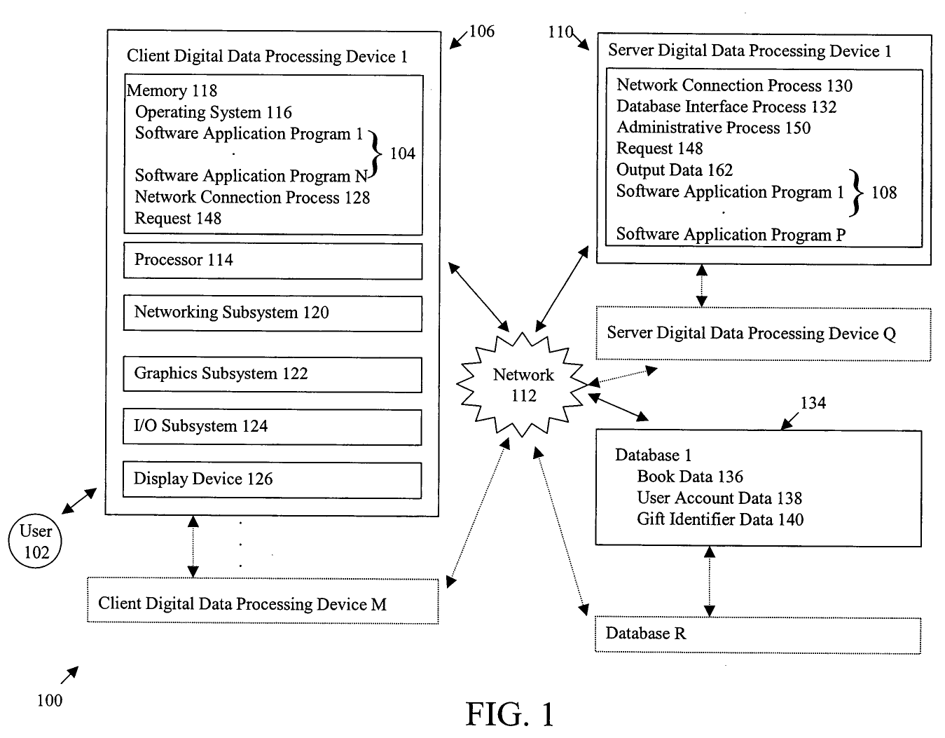

FIG. 1 schematically illustrates an exemplary system for customizing a book as provided herein. As shown in FIG. 1, and notwithstanding the aforementioned references to client and server, one illustrated system 100 can include one or more client digital data processing devices 106 (“client”), one or more server digital data processing devices 110 (“server”), and one or more databases 134. The client 106, the server 110, and the database 134 can communicate using one or more data communications networks 112 (“networks”). The features in a digital data processing device are shown as residing in the client 106. Those of ordinary skill in the art will understand that one or more of the features of the client 106 can be present in the server 110.

As shown in the system 100 of FIG. 1, a user 102 desiring to customize a book can execute one or more software application programs 104 (such as, for example, an Internet browser and/or another type of application program capable of providing an interface to a book-customization program) residing on the client 106 to generate data messages that are routed to, and/or receive data messages generated by, one or more software application programs 108 (e.g., book-customization programs) residing on the server 110 via the network 112. A data message can include one or more data packets, and the data packets can include control information (e.g., addresses of the clients and the servers 106, 110, names/identifiers of the software application programs 104, 108, etc.) and payload data (e.g., data relevant to customize a book, such as a request to customize a book 148 and output data 162 including a customized book).

The software application programs 104 can include one or more software processes (e.g., a calculation process/engine) executing within one or more memories 118 of the client 106. Similarly, the software application programs 108 can include one or more software processes executing within one or more memories of the server 110. The software application programs 108 can include one or more sets of instructions and/or other features that can enable the server 110 to customize a book. As described herein, the software application program 108 can include instructions for processing book data 136 to generate output data 162. The software application programs 104, 108 can be provided using a combination of built-in features of one or more commercially available software application programs and/or in combination with one or more custom-designed software modules. Although the features and/or operations of the software application programs 104, 108 are described herein as being executed in a distributed fashion (e.g., operations performed on the networked client and servers 106, 110), those of ordinary skill in the art will understand that at least some of the operations of the software application programs 104, 108 can be executed within one or more digital data processing devices that can be connected by a desired digital data path (e.g., point-to-point, networked, data bus, etc.).

The digital data processing device 106, 110 can include a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 refers to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof.

The instructions executed by a processor 114 represent, at a low level, a sequence of “0's” and “1's” that describe one or more physical operations of a digital data processing device. These instructions can be pre-loaded into a programmable memory (e.g., an electrically erasable programmable read-only memory (EEPROM)) that is accessible to the processor 114 and/or can be dynamically loaded into/from one or more volatile (e.g., a random-access memory (RAM), a cache, etc.) and/or non-volatile (e.g., a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to customizing books. The operating system 116 can support single-threading and/or multi-threading, where a thread refers to an independent stream of execution running in a multi-tasking environment. A single-threaded system is capable of executing one thread at a time, while a multi-threaded system is capable of supporting multiple concurrently executing threads and can perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g., on a display device 126 and/or in a video memory). Inputs from the user 102 can be received via an input/output (I/O) subsystem 124 and routed to a processor 114 via an internal bus (e.g., system bus) for execution under the control of the operating system 116.

Similarly, a remote user (not shown) can interact with the digital data processing devices 106, 110 over the network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can include a networking subsystem 120 (e.g., a network interface card) to establish the communications link between the devices. The communications link interconnecting the digital data processing devices can include elements of a data communications network, a point to point connection, a bus, and/or another type of digital data path capable of conveying processor-readable data.

In one illustrative operation, the processor 114 of the client 106 executes instructions associated with the software application program 104 (including, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (including, for example, one or more menus, windows, and/or other visual objects) on the display device 126.

The network 112 can include a series of network nodes (e.g., the client and the servers 106, 110) that can be interconnected by network devices and wired and/or wireless communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a server node regardless of dissimilarities in the network topology (e.g., bus, star, token ring), spatial distance (e.g., local, metropolitan, wide area network), transmission technology (e.g., transfer control protocol/internet protocol (TCP/IP), Systems Network Architecture), data type (e.g., data, voice, video, multimedia), nature of connection (e.g., switched, non-switched, dial-up, dedicated, or virtual), and/or physical link (e.g., optical fiber, coaxial cable, twisted pair, wireless, etc.) between the originating and server network nodes.

FIG. 1 shows processes 128, 130, 132, and 150. A process refers to the execution of instructions that interact with operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, a network connection process 128, 130 refers to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended. A database interface process 132 refers to a set of instructions and other elements that enable the server 110 to access the database 134 and/or other types of data repositories to obtain access to, for example, book data 136, user account data 138 (e.g., requesting entity user name, identification information, and contact information, and, receiving entity user name, and contact information), and gift identifier data 140. The accessed information can be provided to the software application program 108 for further processing and manipulation. An administrative process 150 refers to a set of instructions and other features that enable the server 110 to monitor, control, and/or otherwise administer a book customization. For example, the administrative process 150 can a) maintain and update configuration, runtime, and/or session data for the one or more digital data processing devices 106, 110 and/or the software application programs 104, 108 executing on the devices 106, 110, b) provide buffer management, multi-threaded services, and/or data structure management, c) provide initialization parameters to the digital data processing devices 106, 110 and/or the software application programs 104, 108, d) manage groups of objects (e.g., groups of data elements stored on the digital data processing devices 106, 110 and/or stored or otherwise maintained in the database 134, groups of software application programs 104, 108, groups of users authorized to access software application programs 104, 108, groups of licenses, etc.), e) manage relationships between objects in response to messages communicated between the one or more digital data processing devices 106, 110, f) provide one or more support services (e.g., encryption/decryption, compression, path routing, message parsing, message format manipulation, etc.) to the digital data processing devices 106, 110, and/or g) provide load balancing based on, for example, processor usage/availability, network usage/availability, memory usage/availability, software application program usage/availability, message length, and/or message volume. Those of ordinary skill in the art will recognize that, although the illustrated processes 128, 130, 132, and 150 and their features are described with respect to some embodiments, the illustrated processes and/or their features can be combined into one or more processes. One or more of the illustrated processes 128, 130, 132, and 150 can be provided using a combination of built-in features of one or more commercially-available software application programs and/or in combination with one or more custom-designed software modules.

The databases 134 can be stored on a non-volatile storage medium or a device known to those of ordinary skill in the art (e.g., compact disk (CD), digital video disk (DVD), magnetic disk, internal hard drive, external hard drive, random access memory (RAM), redundant array of independent disks (RAID), or removable memory device). As shown in FIG. 1, the databases 134 can be located remotely from the client 106. In some embodiments, the databases 134 can be located locally to the client 106 and/or can be integrated into the client 106. The databases 134 can include distributed databases. The databases 134 can include different types of data content and/or different formats for stored data content. For example, the databases 134 can include tables and other types of data structures.

Book data 136 includes data related to one or more books that can be customized by the system 100. As previously described, a “book” can include an electronic book that can be customized, where as provided herein, such electronic book can be provided to appropriate devices to cause such electronic book to be converted to a non-electronic medium such as, but not limited to, paper. Alternatively and/or in combination, in some embodiments, a “book” can include a non-electronic book that can be customized, e.g., a book printed on a printing medium, such as, but not limited to, paper. Each book in book data 136 includes one or more illustrations and one or more words. In each book, each illustration is described by one or more of the one or more words. As will be understood by those of ordinary skill in the art, each book can include additional items, such as pages of text that do not describe illustrations. For example, in some embodiments, a book can include an illustration, one or more first words describing the illustration, and one or more second words that do not describe the illustration. In one such embodiment, the one or more second words can relate (i.e., “tell”) a story portrayed in part by the illustration. In each book, one or more of the illustrations includes one or more drawings of one or more characters, as the terms illustrations, drawings, and characters are understood by those of ordinary skill in the art. In some embodiments, the books in book data 136 are associated with different titles. In such embodiments, at least some of the titles are associated with unique sets of illustrations and words. In some embodiments, the books in book data 136 are organized into groups of one or more members based on one or more features of the books, such as, but not limited to, the levels of reading complexity (“reading levels”) of the books.

User account data 138 includes data identifying one or more users of the system 100. Generally, user account data 138 includes data identifying the names, contact information, login information, and account balances of the users. The contact information can be based on a wireless and/or a wired telecommunications network and can include one or more of email addresses, facsimile numbers, regular/postal (i.e., non-electronic) mail addresses, and telephone numbers. The login information can include usernames and associated passwords for accessing the system 100. The account balances can include credits and debits associated with the user accounts, such as credits based on payments from users and debits based on purchases by users (e.g., purchases of customized books or gift certificates). In some embodiments, user account data 136 can include logs of user transactions and other information related to interactions between users and the system 100.

In some embodiments, users of system 100 can share user accounts included in user account data 138. For example, two or more users can share one user account in user account data 138. In one such embodiment, the one user account can be associated with a group (e.g., a teacher and a class of students taught by the teacher) and can be accessed by one or more members of the group (e.g., by the teacher and/or one or more students of the class).

Gift identifier data 140 includes data related to gift identifiers generated by the system 100 based on requests for gift certificates. As previously described, in the disclosed systems and methods, a first (requesting) entity can purchase or otherwise request a gift certificate that can be redeemed by a second (receiving) entity (which may be the same as or different than the first entity) for purchase of a product, such as a customized book. Based on a request for a gift certificate, the disclosed systems and methods generate a gift identifier and associate the gift identifier with the gift certificate (e.g., the amount/value of the gift certificate) and one or more of the names and the contact information of the entity who requested the gift certificate (“requesting entity”) and the entity who receives the gift certificate (“receiving entity”). Gift identifier data 140 includes generated gift identifiers and associated information. In one embodiment, the gift value can be a dollar amount, a number of customizable books, and/or a portion thereof.

Generally, as previously described herein, the disclosed systems and methods can customize books including illustrations and words describing the illustrations. The disclosed systems and methods can customize the books based on associating one or more drawings of one or more characters in the illustrations with one or more of a name, a gender, and an appearance selected and/or otherwise provided by a client.

Illustrative displays of graphical user interfaces that facilitate a customization of a book are described herein. The illustrative displays can include one or more check boxes, one or more response boxes, one or more radio buttons, one or more pull-down menus, one or more icons, and/or one or more other visual object to facilitate a customization of the book. Those of ordinary skill in the art will understand that the illustrative displays are to be interpreted in an exemplary manner and that displays different than those shown and described herein can be used within the scope of the present disclosure. For example, features of the illustrative displays can be combined, separated, interchanged, and/or rearranged to generate other displays. As will be understood by those of ordinary skill in the art, the illustrative displays can be provided by a server (e.g., a software application program residing on a server) to a client (e.g., a software application program residing on a client) in system 100. In the following description, the illustrative displays are described within the context of interactions (e.g., requests and responses) between client 106 and server 110 in system 100.

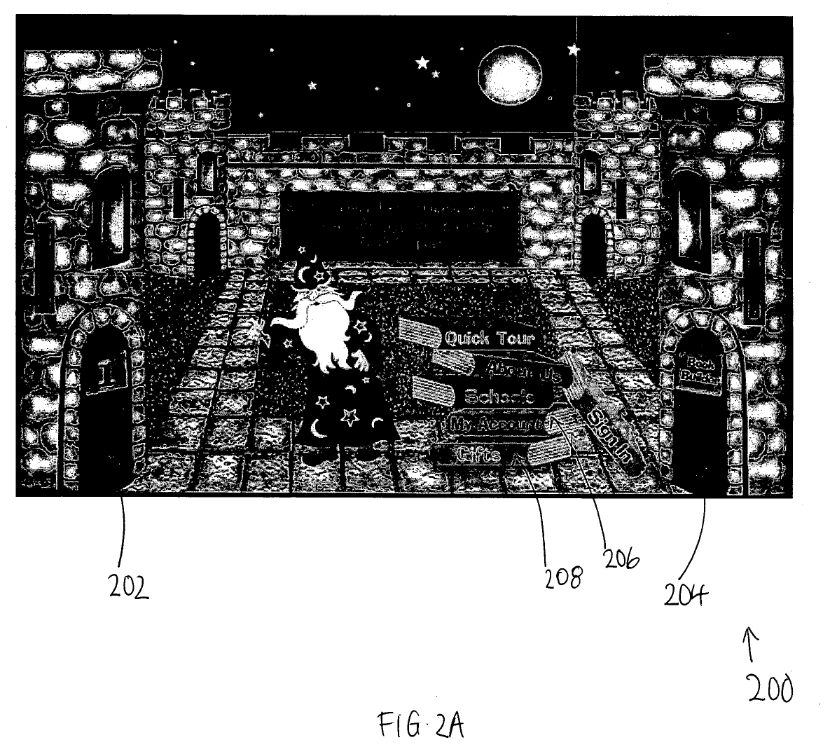

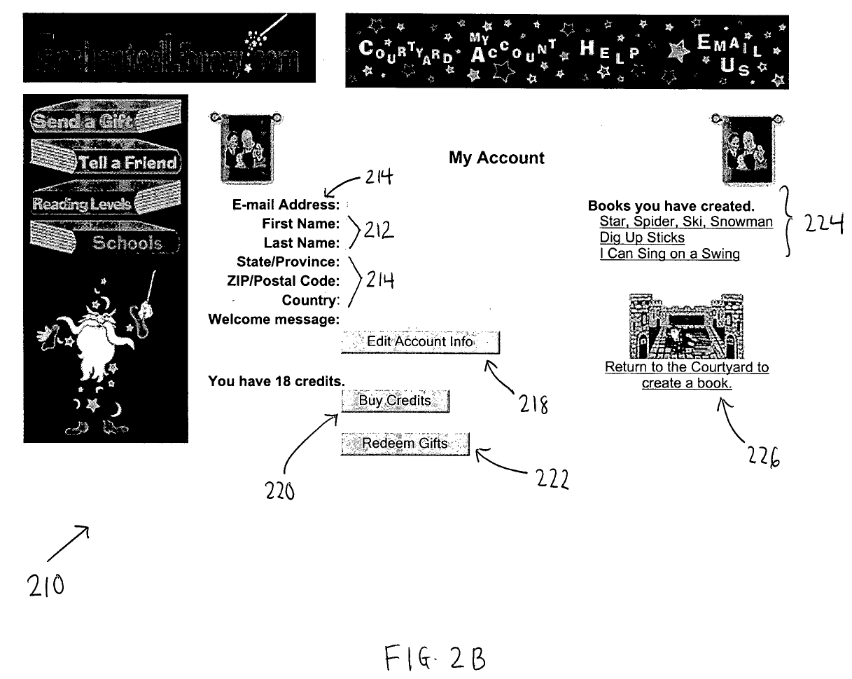

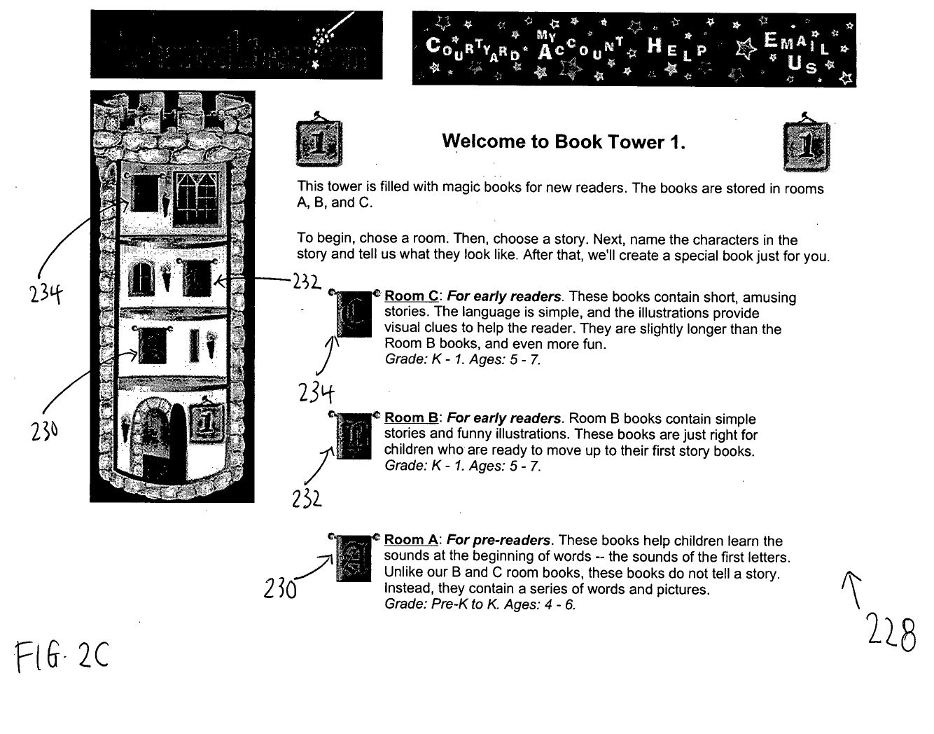

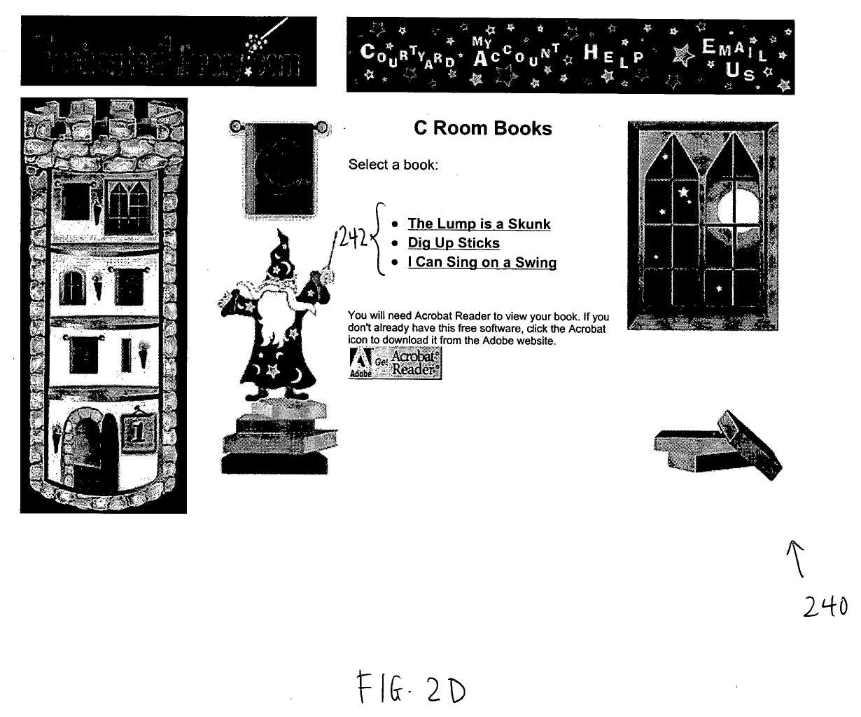

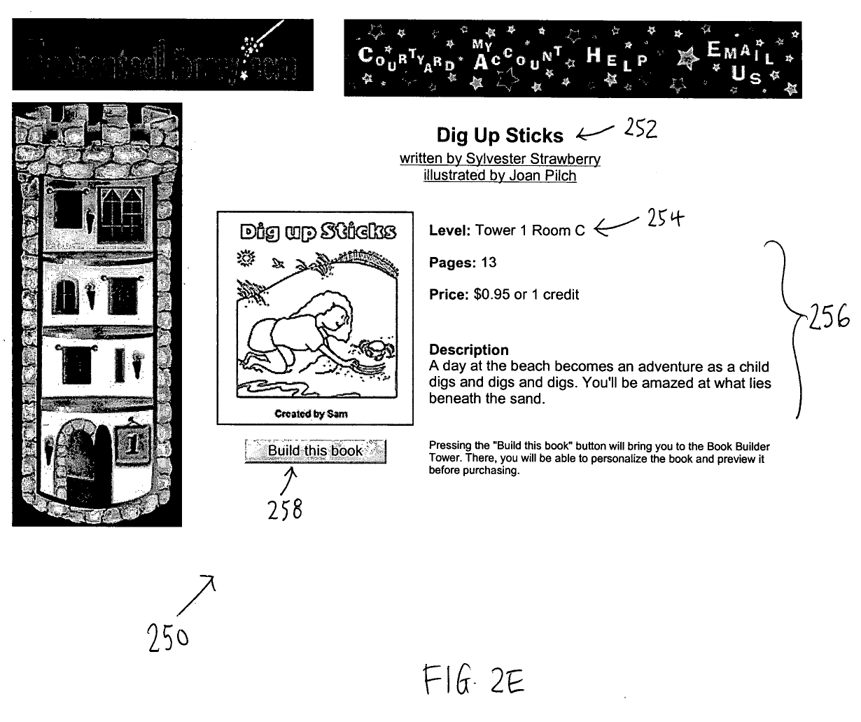

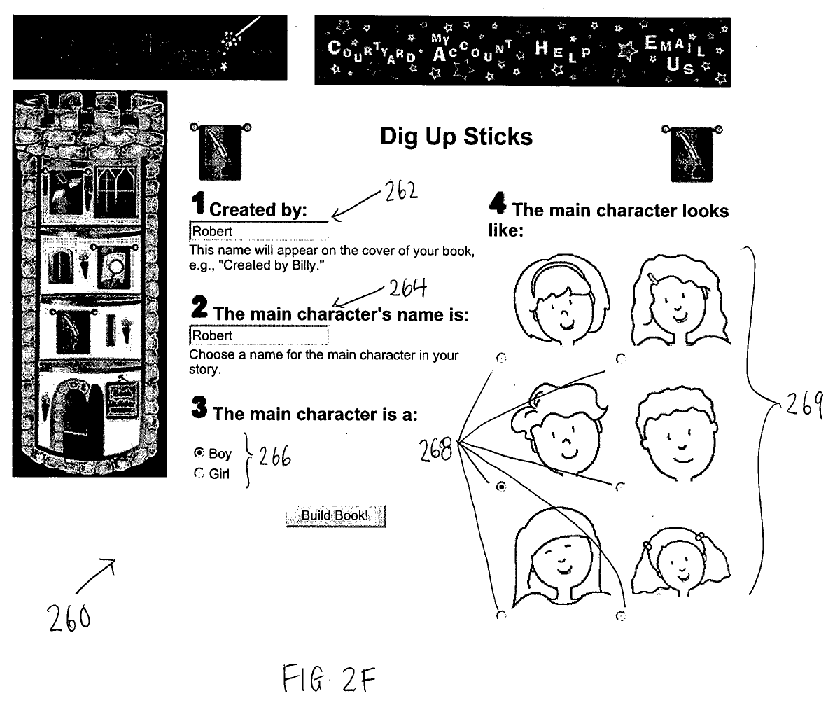

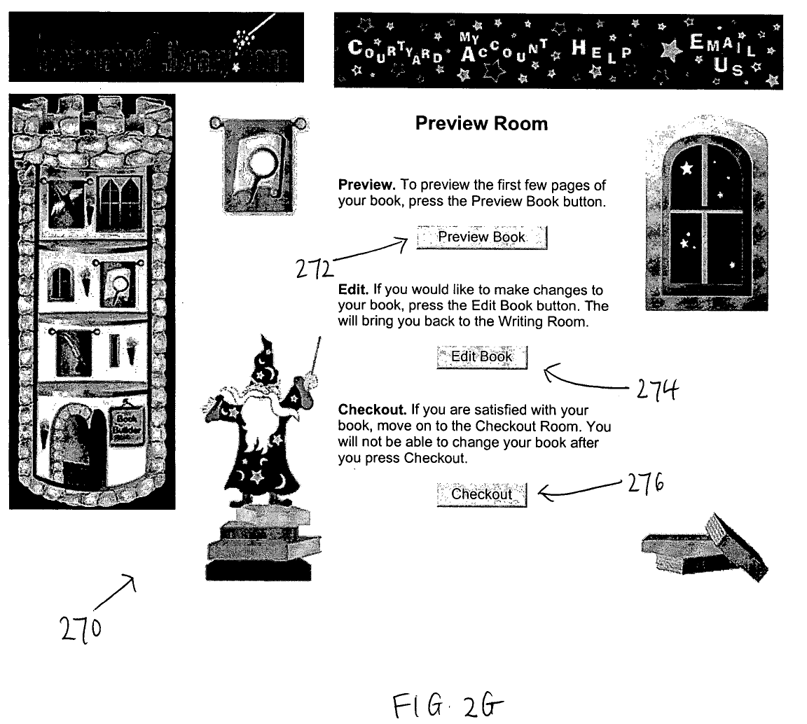

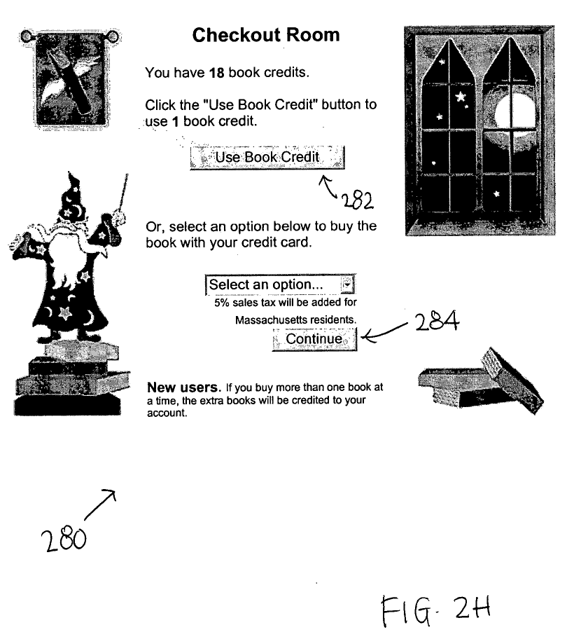

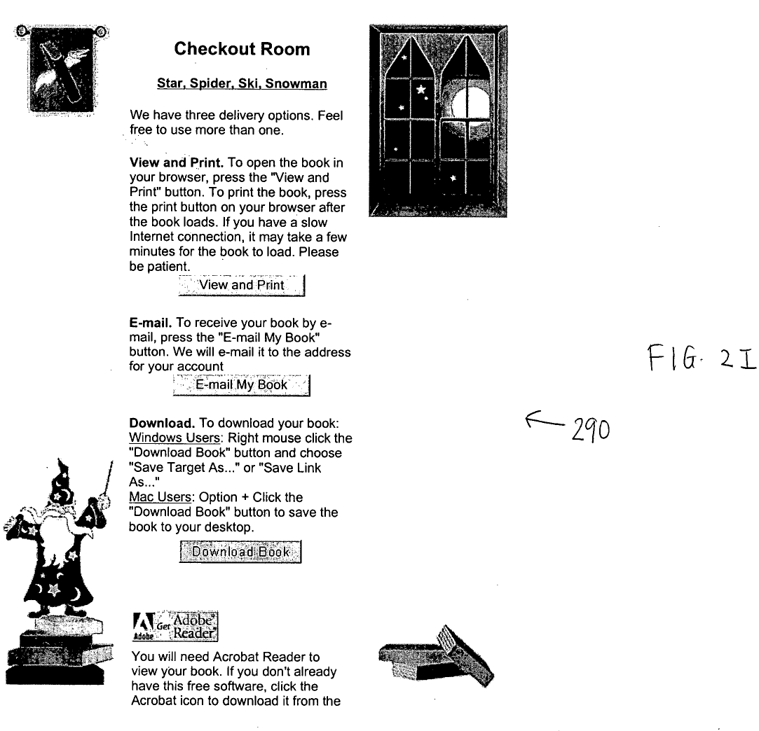

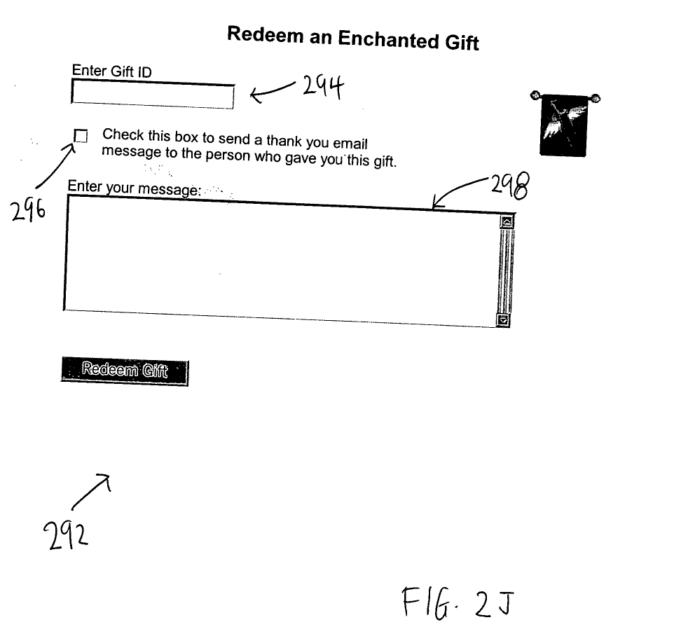

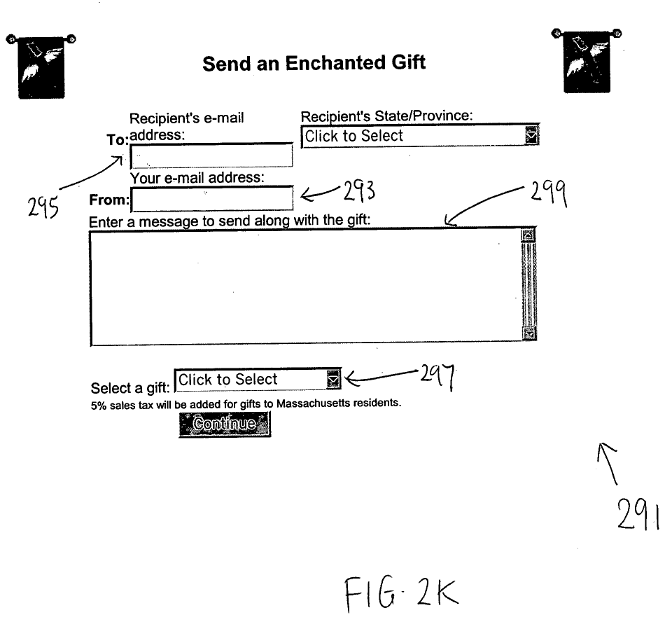

FIG. 2A shows an exemplary welcome window 200 that provides access to the disclosed systems and methods. As shown in FIG. 2A, the welcome window 200 includes one or more icons that can be selected by client 106, such as a book selector icon 202 for selecting a book to be customized, a book customizer icon 204 for customizing a selected book, a user account icon 206 for accessing user account data, and a gift icon 208 for requesting a gift certificate that can be redeemed for purchase of a customized book.

FIG. 2B shows an exemplary user account window 210 that displays information associated with a user account included in user account data 138. The user account window 210 can be provided to client 106 based on receiving at server 110 a selection of the user account icon 206 in the welcome window 200 and login information, such as a username and a password for accessing the system 100. As shown in FIG. 2B, the user account window 210 displays the name 212, the contact information 214 (e.g., an email address and a regular mail address), and, in some embodiments, the login information of the user. As also shown in FIG. 2B, the user account window 210 provides an editor icon 218 for editing the account information, a credit purchase icon 220 for purchasing credits towards purchase of a customized book, a gift certificate icon 222 for redeeming a gift certificate, a log 224 that includes information based on user interactions with the server 110 (e.g., a listing of previously customized books), and a link 226 (e.g., a hypertext transfer protocol (HTTP) link) to selecting and customizing a book.

FIGS. 2C-2E show exemplary displays for selecting a book to be customized. The displays shown in FIGS. 2C-2E can be provided to client 106 based on receiving at server 110 a selection of the book selector icon 202 in the welcome window 200. FIG. 2C displays an exemplary book selection window 228. As previously described, in some embodiments, the disclosed systems and methods can group books available for customization into two or more groups based on the reading levels of the books. In the shown embodiment, the book selection window 228 provides reading level options A (reading level for pre-readers), B (reading level for early readers), and C (reading level for more advanced early readers) and associated icons 230, 232, 234 for selection by client 106. FIG. 2D displays an exemplary title selection window 240 that provides titles 242 of books that are available for customization. In the shown embodiment, the titles 242 are associated with reading level C from the book selection window 228. FIG. 2E displays an exemplary book selection summary window 250 that summarizes features of a book selected by client 106 for customization, such as the selected title 252, the selected reading level 254, and other data 256 (e.g., a number of pages, a price, a description, and one or more sample pages). As also shown in FIG. 2E, the book selection summary window 250 provides a book customization icon 258 for customizing the selected book.

FIGS. 2F and 2G show exemplary displays for customizing a selected book. The displays shown in FIGS. 2F and 2G can be provided to client 106 based on receiving at server 110 a selection of the book customization icon 208 in the welcome window 200 or the book customization icon 258 in the book summary window 250. FIG. 2F shows an exemplary customization window 260 that provides author and character features and associated options for selection by client 106. As shown in FIG. 2F, the customization window 260 includes an author name box 262 in which a client can provide a name of an author of the customized book, a character name box 264 in which a client can provide a name of a character in the book, gender radio-buttons 266 for selecting a gender of the character, and appearance radio-buttons 268 for selecting an appearance, such as a physiognomy, of the character. FIG. 2G shows an exemplary book preview window 270 that includes a preview icon 272 for previewing a customized book, an editor icon 274 for editing the customized book, and a checkout icon 276 for purchasing the customized book. Based on receiving a selection of the preview icon 272, server 110 can provide to client 106, a preview that includes one or more pages of a customized book. Based on receiving a selection of the editor icon 274, server 110 can provide to client 106 book selection window 228 of FIG. 2C and/or the customization window 260 of FIG. 2F, and client 106 can change one or more features of a book for customization, including one or more features of one or more characters included in the book.

FIGS. 2H and 2I show exemplary displays for purchasing a customized book. The displays shown in FIGS. 2H and 2I can be provided to client 106 based on receiving at server 110 a selection of the checkout icon 276 in the book preview window 270. FIG. 2H shows an exemplary checkout window 280 that includes a book credit icon 282 for purchasing the customized book based (in whole or in part) on previously acquired book credits and a book payment icon 284 for purchasing the customized book (in whole or in part) based on a credit-card payment. FIG. 2I shows an exemplary book provision window 290 that includes options for provision of a customized book to client 106. As shown in FIG. 2I, a customized book can be provided to client 106 via email and/or download.

In some embodiments, customized books can be purchased on a book-by-book basis. For example, in one such embodiment, a user of the system 100 can purchase a customized book based on providing a payment for the customized book (e.g., one dollar per book). Alternatively and/or in combination, in some embodiments, customized books can be purchased on a subscription basis. For example, in one such embodiment, a user of the system 100 can purchase a subscription to the system 100 that allows the user to purchase an unlimited number of books during a time period for a flat price (e.g., ten dollars for a one-month subscription). In some embodiments, users can be offered a subscription based on their association with one or more group accounts in user account data 138 (e.g., the previously described classroom accounts).

FIG. 2J shows an exemplary gift certificate redemption window 292. The display shown in FIG. 2J can be provided to client 106 based on receiving at server 110 a selection of the gift certificate icon 222 in the user account window 210. As shown in FIG. 2J, the gift certificate redemption window 292 includes a gift identifier box 294 for providing a gift identifier, a check box 296 for selecting whether to provide a message to the entity who requested the gift certificate associated with the gift identifier, and a customized message box 298 for providing a customized message to the entity.

FIG. 2K shows an exemplary gift certificate request window 291. The display shown in FIG. 2K can be provided to client 106 based on receiving at server 110 a selection of the gift icon 208 in the welcome window 200. As shown in FIG. 2K, the gift certificate request window 291 can include a requester box 293 for providing contact information for the requesting entity, a recipient box 295 for providing contact information for the receiving entity, a pull-down menu 297 for selecting an amount (e.g., an amount in terms of a negotiable currency, such as dollars, and/or in terms of customized books) of the gift certificate, and a message box 299 for providing a message to the receiving entity.

In one illustrative operation and with reference to FIGS. 1 and 2A-2K, the software application program executing within the memory 118 of the client 106 can detect a request 148 to customize a book from the user 102 by, for example, receiving an indication of such selection from the I/O subsystem 124 that detected a mouse click, a keyboard entry, and/or another input event initiated by the user 102, such as a selection of the book customization icon 204 in welcome window 200 or book customization icon 258 in book selection summary window 250 of FIG. 2E. In response to the user request, the software application program 104 can access a set of character features supported by the software application program 104 and can instruct the graphics subsystem 122 (via the processor 114) to display the supported character features in a graphical user interface (e.g., the customization window 260 of FIG. 2F). The user 102 can then initiate another input event corresponding to, for example, a selection of an appearance option from a set of supported appearance options. Similar sequences of input events and detections by the software application program 104 can enable the user 102 to specify one or more additional parameters that define a book customization request of interest, which can include one or more of a reading level, a title, an author name, a character name, a character gender, and a character appearance. The request 148 and its associated parameters selected by the user 102 can be maintained in the memory 118 of the client 106 prior to transmission to the server 110 via the network 112. The software application program 104 can apply one or more rules to the request 148 to reduce the occurrence of erroneous requests. One or more of these rules can be contained in memory 118. Alternatively and/or in combination, the software application program 104 can access one or more of these rules from the database 134 via the network 112. As will be understood by those of ordinary skill in the art, in one embodiment, the software application program 104 can apply one or more data validation rules to the request 148 to determine the validity of the parameters associated with the request 148 and notify the user 102 of errors.

With continuing reference to FIGS. 1 and 2A-2K, the software application program 104 can instruct the network connection process 128 of the client 106 to transmit the parameters associated with the request 148 selected by the user 102 to a calculation process or another software process associated with the software application program 108 executing on the server 110 by, for example, encoding, encrypting, and/or compressing the selected request 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108. The software application program 108 can process the request 148 by, for example, associating one or more drawings of one or more characters in the illustrations of a selected book included in book data 136 with one or more of a selected character name, a selected character gender, and a selected character appearance.

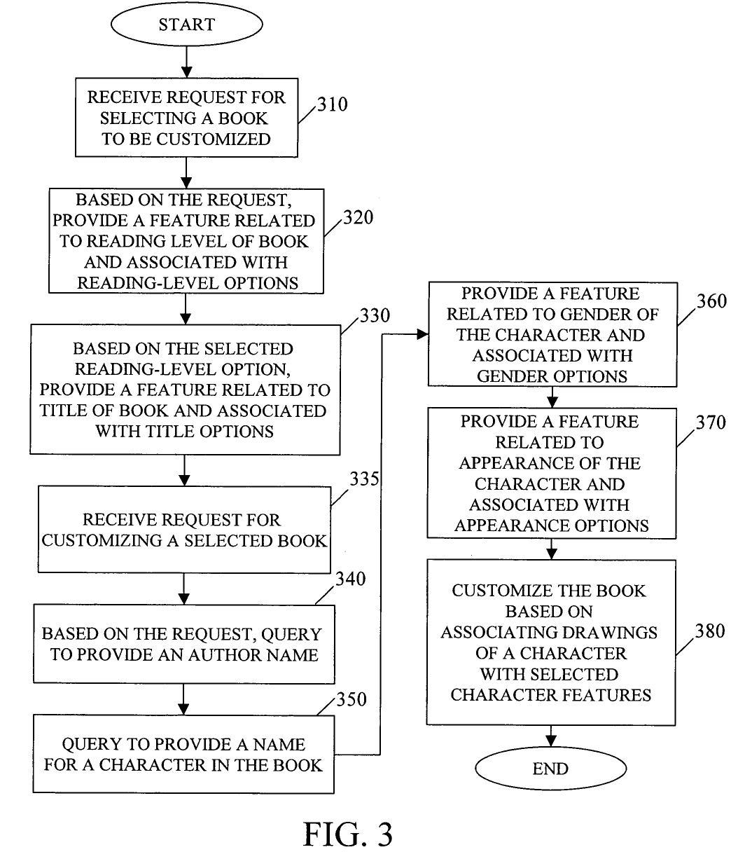

In the disclosed systems and methods, a server (e.g., server 110) can query a client (e.g., client 106) to select (via, for example, pull-down menus, check boxes, and/or radio buttons) and/or otherwise provide (via, for example, response boxes) one or more features of a book to be customized, such as a reading level of the book and a title of the book, and/or one or more features of one or more characters included in the book, such as a name, a gender, and an appearance of a character. FIG. 3 schematically illustrates one embodiment of a method for customizing a book. In FIG. 3, flow elements 310, 320, and 330 represent selection of a book to be customized, and flow elements 335, 340, 350, 360, 370, and 380 represent customization of the selected book. As will be understood by those of ordinary skill in the art, the disclosed systems and methods can include flow elements that are different than those shown and described in FIG. 3.

As shown in FIG. 3, a request from a client (e.g., client 106) for selecting a book to be customized is received at a server (e.g., server 110) in system 100 (310 in FIG. 3). Based on receiving the request, server 110 (e.g., a software application program 108 residing on server 110) can provide a first book feature related to the reading level of the book and associated with reading level options for selection by client 106 (320 in FIG. 3). For example, server 110 can provide the first book feature via the book selection window 228 of FIG. 2C. Based on receiving a selected reading level option, server 110 can provide a second book feature related to the title of the book and associated with title options for selection by client 106 (330 in FIG. 3). For example, server 110 can provide the second book feature via the title selection window 240 of FIG. 2D.

With continuing reference to FIG. 3, a request from client 106 for customizing a book, such as the book associated with the reading level and title of flow elements 320 and 330, is received at server 110 (335 in FIG. 3). Based on receiving the request, server 110 queries client 106 to provide a name of an author of the customized book (340 in FIG. 3). For example, server 110 can query client 106 to provide the name via the author name box 262 of the customization window 260 in FIG. 2F.

As shown in FIG. 3, based on receiving the request to customize the book, server 110 queries the client to select and/or otherwise provide one or more features of one or more characters in the book, i.e., one or more characters included in at least one drawing of at least one illustration in the book. For purposes of illustration, the method of FIG. 3 is described with respect to selecting features of one character. Server 110 queries client 106 to provide a name of a character (350 in FIG. 3). For example, server 110 can query client 106 to provide the name via the character name box 264 of customization window 260 in FIG. 2F. Server 110 provides a character gender feature related to the gender of a character (e.g., the gender of the named character) and associated with male and female options for selection by client 106 (360 in FIG. 3). For example, server 110 can provide the gender options via the gender radio-buttons 266 in the customization window 260 of FIG. 2F. Server 110 can provide a character appearance feature related to the appearance of a character (e.g., the appearance of the named character) and associated with character appearance options for selection by client 106 (370 in FIG. 3). For example, server 110 can provide the appearance options via the appearance radio-buttons 268 in the customization window 260 of FIG. 2F.

In the customization window 260, the shown appearance options 269 are based on the appearance of humans and include options for male and female appearances based on different ethnicities, such as, but not limited to, African, Caucasian, Hispanic, and Asian. Alternatively and/or in combination, in some embodiments, the appearance options can be based on the appearance of non-humans, including living non-humans (e.g., deer, bears, turtles, etc.), and non-living non-humans (e.g., scarecrows, snowmen, etc.). The shown appearance options 269 are based on the appearance of human physiognomies. Alternatively and/or in combination, in some embodiments, the appearance options can be based on partial-body appearances (e.g., physiognomies, torsos, etc.) and/or whole-body appearances.

With continuing reference to FIG. 3, server 110 can customize a book based on associating one or more drawings of one or more characters included in one or more illustrations of the book with one or more character features selected by client 106 (380 in FIG. 3). For example, server 110 can associate a drawing of a character with a selected appearance option and one or more words including a provided character name, a pronoun consistent with a selected character gender, and a word including a possessive adjective consistent with the selected character gender.

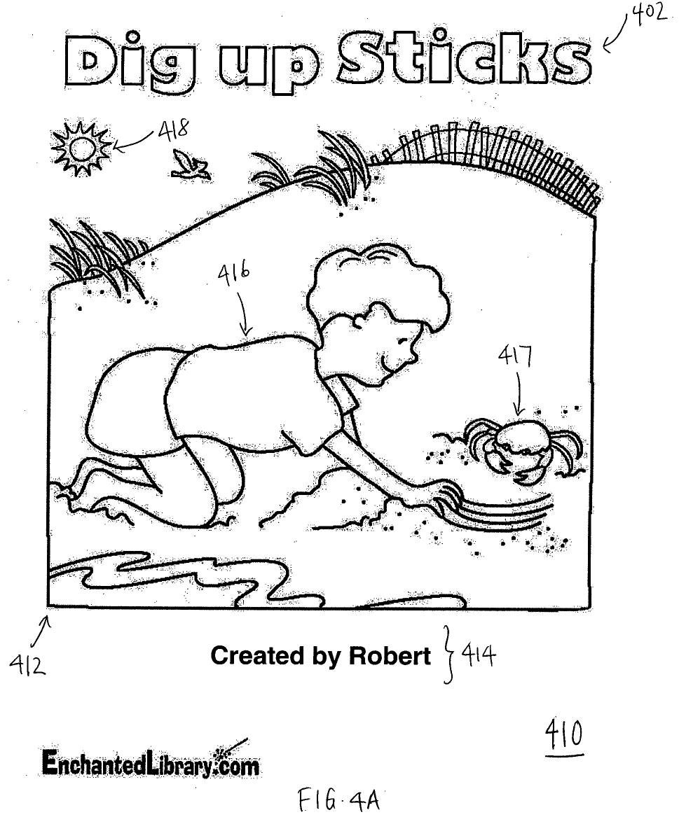

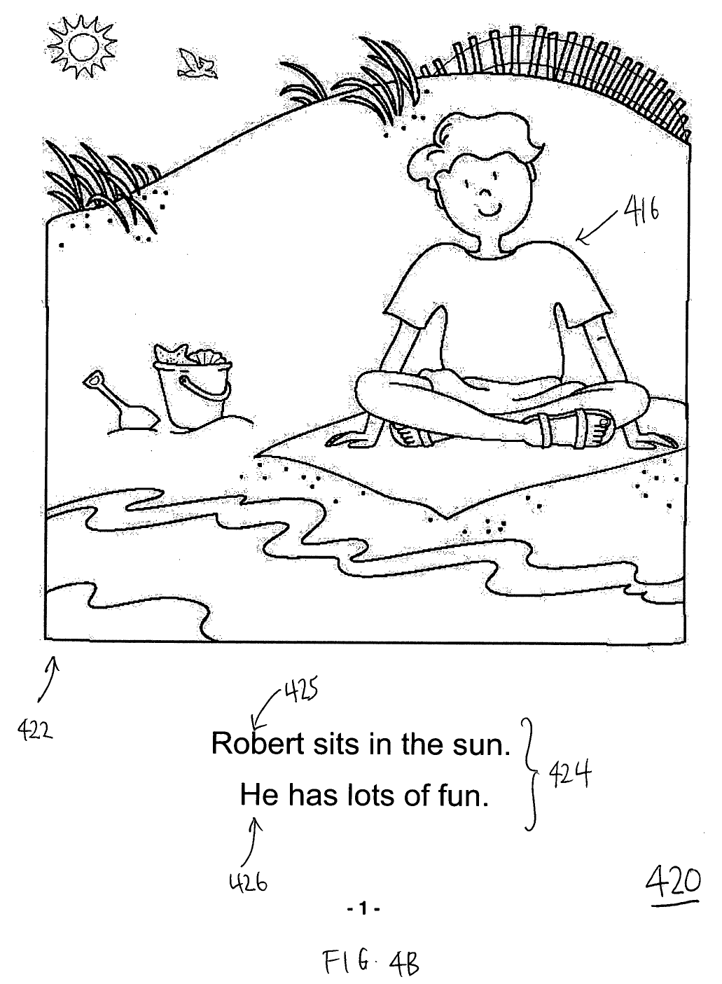

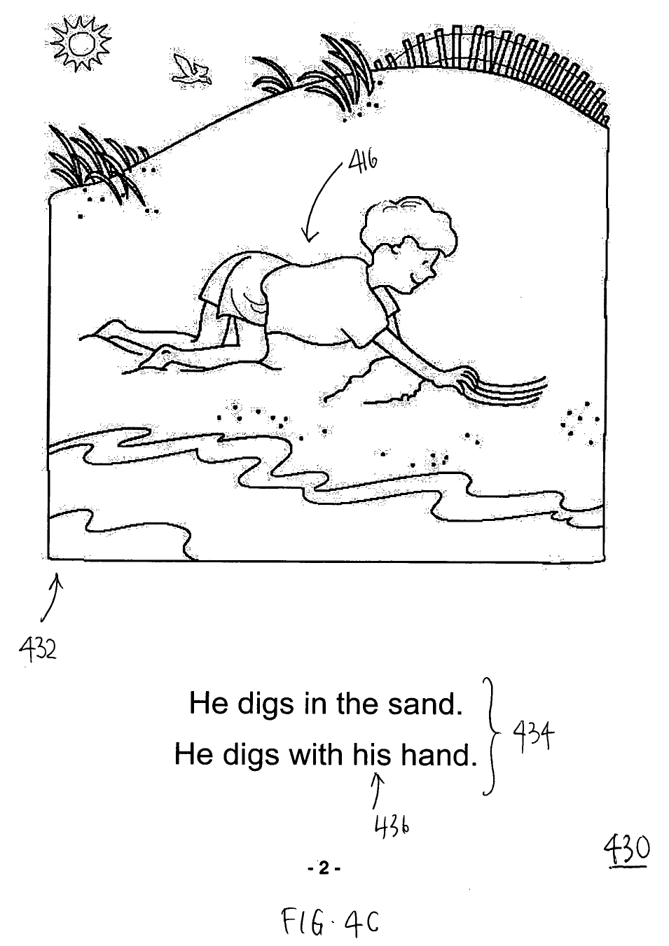

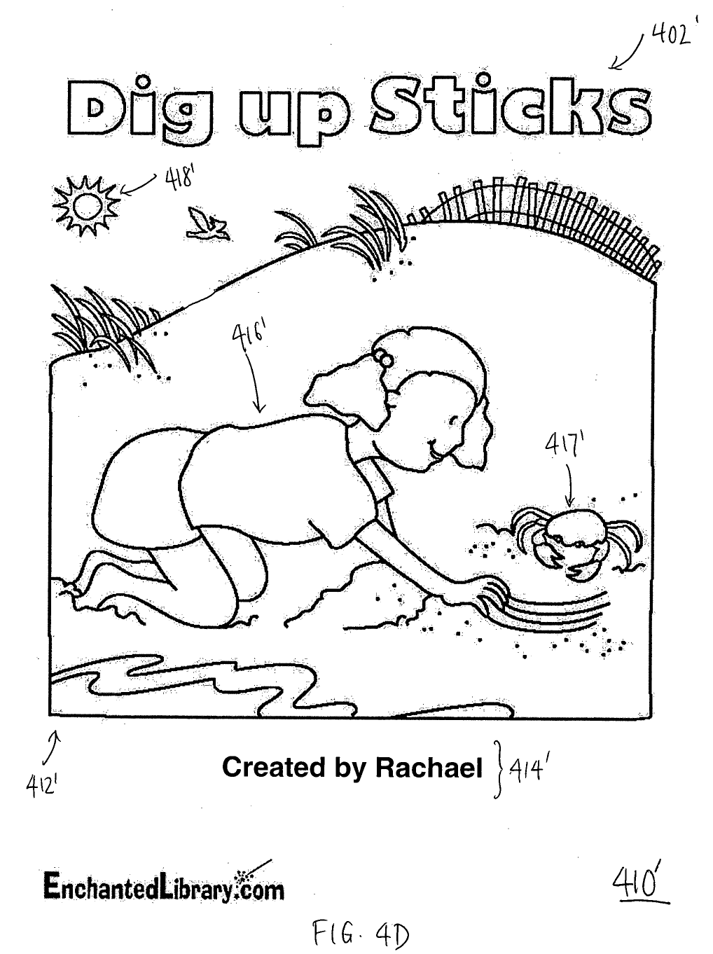

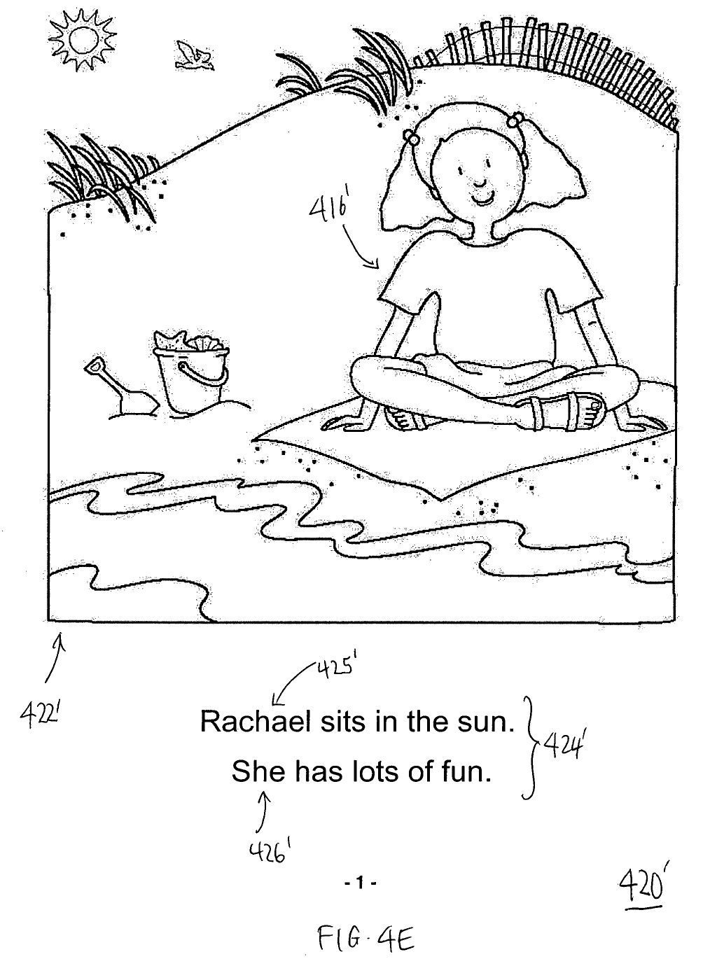

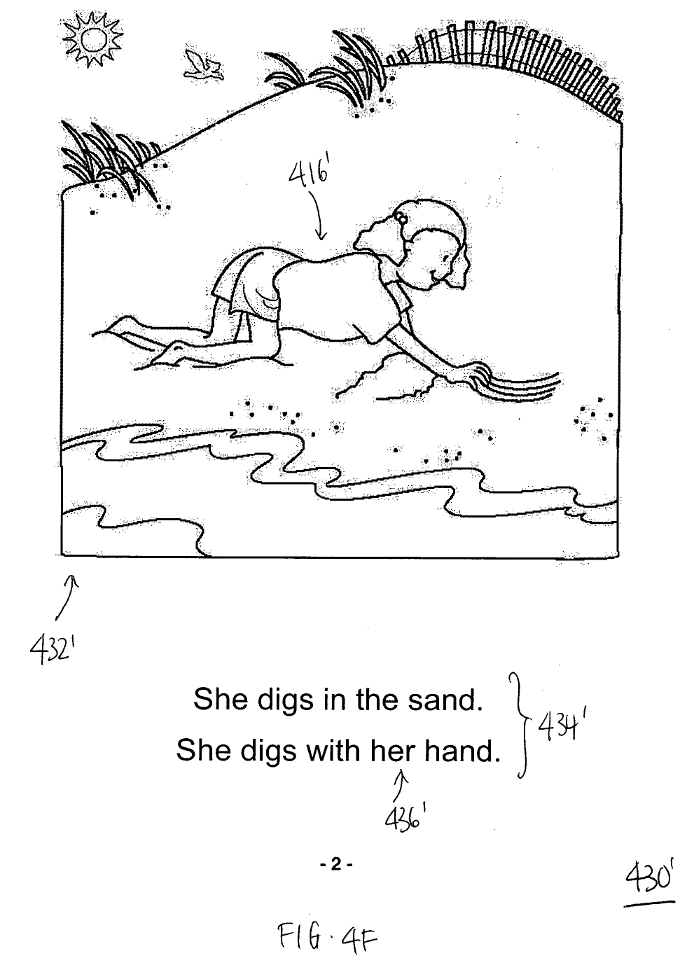

FIGS. 4A-4F illustrate two exemplary customized books. The exemplary customized book of FIGS. 4A-4C is based on a first set of features (e.g., the selected features in FIGS. 2A-2K) and the exemplary customized book of FIGS. 4D-4F is based on a different second set of features. As will be understood by those of ordinary skill in the art, the exemplary customized books should be interpreted in an illustrative manner, and the disclosed systems and methods can generate customized books that include features that are different than those shown and described herein.

General features of the exemplary customized books of FIGS. 4A-4F are now described. As shown in FIGS. 4A-4C, an exemplary customized book can include pages 410, 420, and 430 with illustrations 412, 422, and 432 and associated words 414, 424, and 434 that describe the illustrations 414, 424, and 434. (Similar features in FIGS. 4D-4F are denoted with primed reference numerals.) In the shown embodiment, the words 414, 424, and 434 describing the illustrations 412, 422, and 432 appear on the same pages as the illustrations 412, 422, and 432. Alternatively and/or in combination, words that describe an illustration can appear on one or more pages other than the page of the illustration. For example, in some embodiments, words that describe an illustration can be provided on a page facing the page of the illustration, i.e., a page consecutive with the page of the illustration. As shown in FIGS. 4A-4C, the illustrations 412, 422, and 432 include drawings of characters 416, 417, and 418. The characters 416, 417, and 418 in the shown embodiment include living beings and non-living beings. As previously described, the term character as used herein refers to the understanding of character by one of ordinary skill in the art, and can include living beings and non-living beings. The shown illustrations 412, 422, 432 include black outlines for guiding coloring, like the illustrations of a coloring book. Alternatively and/or in combination, one or more of the illustrations can be presented partially or fully colored.

Specific features of the exemplary customized books of FIGS. 4A-4F are now described. As shown in FIGS. 4A and 4D, pages 410 and 410′ present the selected titles 402 and 402′ and the different selected authors 414 and 414′ of the customized books. In FIGS. 4A-4C and 4D-4F, character drawings 416 and 416′ are associated with different selected character appearance options, i.e., a male Caucasian appearance option in FIGS. 4A-4C, and a female Caucasian appearance option in FIGS. 4D-4F. As shown in FIGS. 4B and 4E, pages 420 and 420′ present drawings of the characters 416 and 416 in illustrations that are associated with words 424 and 424′. In pages 420 and 420′, the words 424 and 424′ include different selected character names 425 and 425′ and different pronouns 426 and 426′ (here, subject pronouns) that are consistent with different selected gender options for the characters 416 and 416′, i.e. male in FIGS. 4A-4C and female in FIGS. 4D-4F. As shown in FIGS. 4C and 4F, pages 430 and 430′ present illustrations associated with words 434 and 434′ that include different possessive adjectives 436 and 436′ that are consistent with the selected gender options for the characters 416 and 416′.

As previously described, the disclosed systems and methods relate to generating gift identifiers based on requests for gift certificates and redeeming and/or otherwise employing the associated, generated gift identifiers to purchase products. As used herein, gift certificate refers to the understanding of the term gift certificate by one of ordinary skill in the art and can include a financial instrument that can be redeemed for purchase of a product including a good or a service, such as, but not limited to, a customized book.

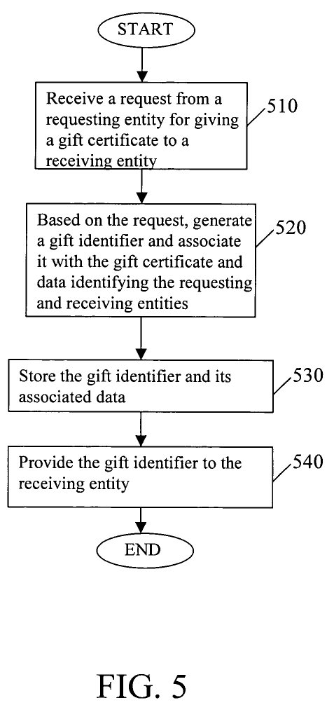

FIG. 5 schematically illustrates an embodiment of a method for generating a gift identifier based on a request for a gift certificate. As shown in FIG. 5, a request from a first entity (a “requesting entity,” e.g., client 106) for giving a gift certificate to a second entity (a “receiving entity,” e.g., another client) can be received at server 110 of system 100 (510 in FIG. 5). In one embodiment, the requesting entity can request the gift certificate based on accessing the gift certificate request window 291 of FIG. 2K. The request for the gift certificate can include an amount/value of the gift certificate (e.g., an amount in terms of a negotiable currency, such as dollars, and/or in terms of a product, such as customized books) and data that identifies the requesting and receiving entities. Such data can include the names (e.g., usernames and/or actual names) and/or the contact information of the requesting and receiving entities (e.g., contact information based on wired and/or wireless telecommunications networks, such as email addresses, facsimile numbers, regular addresses, and telephone numbers). In some embodiments, the request can include a message from the requesting entity to the receiving entity. For example, the requesting entity can provide such a message via the message box 299 in the gift certificate request window 291 of FIG. 2K. Based on receiving the request, server 110 generates a gift identifier and associates the gift identifier with the gift certificate (i.e., the amount of the gift certificate), data identifying the requesting and receiving entities (e.g., the names and/or the contact information of the entities) and, in some embodiments, a message provided by the requesting entity (520 in FIG. 5). The gift identifier includes an alphanumeric string that is generated based on data compression and/or data encryption schemes known to those of ordinary skill in the art. The server 110 stores the gift identifier and its associated data in gift identifier data 140 in database 134 (530 in FIG. 5). Subsequently, the server 110 provides the gift identifier (while maintaining a copy of the gift identifier in database 134) and, in some embodiments, an associated message from the requesting entity, to the receiving entity (540 in FIG. 5) via network 112. For example, in one embodiment, the server 110 can email the gift identifier to the receiving entity based on the contact information included in the request for the gift certificate.

As previously described, the disclosed systems and methods provide gift identifiers to receiving entities based on requests from requesting entities for giving gift certificates to the receiving entities. In some embodiments, the disclosed systems and methods provide the names and/or the contact information of the requesting entities to the receiving entities. For example, in some embodiments, the disclosed systems and method provide a gift identifier to a receiving entity in a message (e.g., an email message) that includes the name and/or the contact information of a requesting entity. Alternatively, in some embodiments, the disclosed systems and methods do not provide the names and the contact information of the requesting entities to the receiving entities, or vice-versa, however, login (general, specific) and/or user-names can be provided in some embodiments. For example, in some embodiments, server 110 provides only the gift identifiers (and any message provided by the requesting entities) to the receiving entities. Generally, the receiving entities cannot infer the identifies of the requesting entities from the gift identifiers because the gift identifiers are, as previously described, generated based on data compression and/or data encryption schemes known to those of ordinary skill in the art. As such, the disclosed systems and methods are capable of generating gift identifiers that render requesting entities anonymous to the receiving entities. The disclosed systems and methods can preserve the anonymity of the requesting entities during redemption of the gift identifiers by the receiving entities.

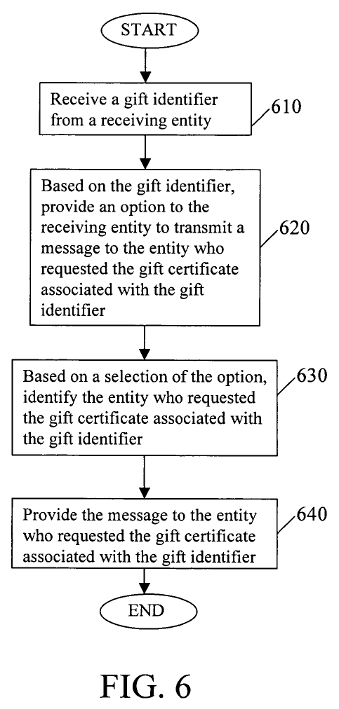

FIG. 6 schematically illustrates an embodiment of a method for redeeming a gift identifier for purchase of a product. As shown in FIG. 6, a receiving entity (e.g., client 106) can redeem a gift identifier by providing it to server 110 in system 100 (610 in FIG. 6). The receiving entity can provide the gift identifier to server 110 based on, for example, accessing the gift certificate redemption window 292 of FIG. 2J. Based on receiving the gift identifier, server 110 can provide the receiving entity with an option to transmit a message to the entity who requested the gift certificate associated with the gift identifier (620 in FIG. 6). Server 110 can provide the option to the receiving entity without revealing the name and/or the contact information of the requesting entity, i.e., while preserving an anonymity of the requesting entity. (Alternatively, in some embodiments, server 110 can reveal to the receiving entity the name and/or the contact information of the requesting entity during provision of the option.) In some embodiments, server 110 can provide the receiving entity with a first option for transmitting a pre-determined message that expresses gratitude to the entity who requested the gift certificate and a second option for transmitting a customized message to the entity who requested the gift certificate. For example, in one embodiment, the server can provide the first option via the check box 296 and the second option via the response box 298 in the gift certificate redemption window 292 of FIG. 2J. Based on receiving a selection of the option to provide a message, server 110 identifies the entity who requested the gift identifier, i.e., determines at least the contact information of the entity who requested the gift certificate associated with the received gift identifier (630 in FIG. 6). Server 110 identifies the entity who requested the gift certificate associated with the received gift identifier based on comparing the received gift identifier with one or more of the gift identifiers stored in gift identifier data 140 in database 134. For example, server 110 can determine the identity of the entity who requested the gift certificate associated with the received gift identifier based on a match between the received gift identifier and a stored gift identifier. Server 110 transmits the message to the identified requesting entity based on the contact information associated with the stored gift identifier that matches the received gift identifier (640 in FIG. 6). In some embodiments, server 110 transmits the message without revealing to the receiving entity the identity and the contact information of the requesting entity, thus preserving an anonymity of the requesting entity. (Alternatively, in some embodiments, server 110 can reveal to the receiving entity the identity and/or the contact information of the requesting entity during transmission of the message.)

As will be understood by those of ordinary skill in the art, the disclosed systems and methods are not limited to gift identifiers that can render a requesting entity anonymous to a receiving entity. For example, in some embodiments, the disclosed systems and methods can receive requests for gift certificates, associate the gift certificates (as distinct from a generated gift identifier) with data identifying at least the requesting entities (e.g., associate gift certificate numbers with data identifying the requesting entities), and provide the requested gift certificates to the requesting entities. Subsequently, based on receiving a gift certificate (e.g., during purchase of a product), the disclosed systems and methods can provide an option to the redeeming entity to provide a message to the entity who requested the gift certificate. Based on receiving a selection of the option, the disclosed systems and methods can identify the entity who requested the gift certificate based on the schemes described herein (e.g., by comparing a received gift certificate number with previously stored gift certificate numbers) and provide the message to the entity.

The systems and methods described herein are not limited to a hardware or software configuration; they can find applicability in many computing or processing environments. The systems and methods can be implemented in hardware or software, or in a combination of hardware and software. The systems and methods can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

Unless otherwise provided, references herein to memory can include one or more processor-readable and accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application.

Unless otherwise provided, references herein to a/the processor and a/the microprocessor can be understood to include one or more processors that can communicate in stand-alone and/or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application-specific integrated circuit, and/or a task engine, with such examples provided for illustration and not limitation.

Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims.

For example, the disclosed systems and methods are not limited to customizing characters included in a book, but can customize other components of a book, such as the setting of a book (e.g., a location and a time period of the setting), the plot of the book (e.g., a type of plot, such as comedy, drama, and mystery, and a set of events in the book), etc., as the terms setting and plot are understood by those of ordinary skill in the art.

Also for example, the disclosed systems and methods are not limited to customizing books. Generally, the disclosed systems and methods can customize features of one or more media, such as, but not limited to, video media (e.g., books, such as, but not limited to, books in which illustrations are non-animated and books in which illustrations are animated), audio media (e.g., songs), audio-video media (e.g., singing song books, such as, but not limited to, singing song books in which one or more illustrations are animated and/or one or more illustrations are non-animated), based on the schemes described herein. For example, in some embodiments, the disclosed systems and methods can provide one or more song features associated with one or more selectable options and/or one or more singing song book features associated with one or more selectable options. The song and/or singing songbook features can include one or more of an author name, a level of complexity, a title, character name(s), character gender(s), theme(s), etc.

Also for example, the disclosed systems and methods are not limited to generating gift identifiers that can be redeemed for purchase of customized books, but can generate gift identifiers that can be redeemed for purchase of a variety of goods and services.

Also for example, the disclosed systems and methods are not limited to providing options for transmitting pre-determined and/or customized messages from a receiving entity of a gift identifier to a requesting entity of the gift identifier. Generally, the disclosed systems and methods can provide options for transmitting messages that include selectable and/or pre-determined video components (e.g., text and/or graphics, such as illustrations) and/or audio components (e.g., speech and/or music).

Accordingly, the systems and methods described herein are not to be limited to the embodiments described herein, can include practices other than those described, and are to be interpreted as broadly as allowed under prevailing law.

What is claimed is:

1. A method for customizing a book, the method comprising:
receiving a request to customize a book including illustrations and associated words describing the illustrations, at least one of the illustrations including at least one drawing of at least one character,
based on the request, performing at least one of:
querying to provide a name for one or more of the at least one character,
providing a character appearance feature, the appearance feature: (i) related to the appearance of one or more of the at least one character, and (ii) associated with selectable appearance options,
providing a character name feature, the character name feature: (i) related to the name of one or more of the at least one character, and (ii) associated with selectable name options, and
providing a character gender feature, the character gender feature: (i) related to the gender of one or more of the at least one character, and (ii) associated with selectable gender options, and
customizing the book based on associating one or more of the at least one drawing with at least one of:
a selected appearance option,
at least one word including one of: a provided name and a selected name option,
at least one word including a pronoun consistent with a selected gender option, and
at least one word including a possessive adjective consistent with the selected gender option.

2. The method of claim 1, wherein the appearance options are based on the appearance of one or more of: humans and non-humans.

3. The method of claim 2, wherein the appearance options based on the appearance of humans include male and female appearance options.

4. The method of claim 2, wherein the appearance options based on the appearance of humans include ethnicity-based appearance options.

5. The method of claim 1, wherein the appearance options include one or more of: whole-body-based appearance options, partial-body-based appearance options, and physiognomy-based appearance options.

6. The method of claim 1, wherein the illustrations include outlines for coloring.

7. The method of claim 1, wherein the book includes one of: an electronic book and a non-electronic book.

8. The method of claim 1, further comprising:
based on the request, performing at least one of:
querying to provide a name for the author of the customized book, and
providing an author name feature, the author name feature: (i) related to the name of the author of the customized book, and (ii) associated with selectable name options.

9. The method of claim 1, further comprising:
based on the request, providing a plot feature, the plot feature: (i) related to the plot of the customized book, and (ii) associated with selectable plot options.

10. The method of claim 1, further comprising:
based on the request, providing a first book feature, the first book feature: (i) related to the reading level of the book, and (ii) associated with selectable reading-level options.

11. The method of claim 10, further comprising:
based on a selected reading-level option, providing a second book feature, the second book feature: (i) related to the title of the book, and (ii) associated with selectable title options, at least two of the title options being associated with unique sets of words and accompanying illustrations.

12. The method of claim 1, further comprising:
providing a preview including at least one page of the customized book.

13. The method of claim 1, further comprising:
providing an option to change at least one of: at least one selected appearance option, at least one selected name option, and at least one selected gender option.

14. The method of claim 1, further comprising:
receiving a gift identifier associated with a gift certificate redeemable for purchase of the customized book, and data associated with the entity who requested the gift certificate,
providing an option to send a message to the entity who requested the gift certificate associated with the received gift identifier, and
based on receiving a selection of the option, sending the message to the entity who requested the gift certificate.

15. The method of claim 14, wherein providing the option includes:
providing the option without revealing at least one of the identity and contact information of the entity who requested the gift certificate.

16. The method of claim 14, wherein the gift identifier is generated based on one or more of a data compression scheme and a data encryption scheme of data associated with the entity who requested the gift certificate.

17. The method of claim 14, wherein the message includes one or more of: a video component and an audio component.

18. The method of claim 14, wherein providing the option includes:
providing,
a first option for providing a pre-determined message to the entity who requested the gift certificate, and
a second option for providing a customized message to the entity who requested the gift certificate,

19. The method of claim 18, wherein the pre-determined message expresses gratitude to the entity who requested the gift certificate associated with the received gift identifier.

20. The method of claim 14, wherein sending the message includes:
identifying the entity who requested the gift certificate based on comparing the received gift identifier with at least one previously stored gift identifier, each of the at least one previously stored gift identifier being associated with a gift certificate and data identifying the entity who requested the gift certificate.

21. The method of claim 20, wherein identifying the entity further includes:
identifying the entity who requested the gift certificate based on a match between the received gift identifier and one of the at least one previously stored gift identifier.

22. The method of claim 14, wherein sending the message to the entity includes:
sending the message to the entity without revealing at least one of:
the identity of the entity who requested the gift certificate, and,
contact information of the entity who requested the gift certificate.

23. A processor program for customizing a book, the processor program being stored on a processor-readable medium and comprising instructions to cause a processor to:
receive a request to customize a book including illustrations and associated words, at least one of the illustrations including at least one drawing of at least one character,
based on the request, perform at least one of:
generate a query to provide a name for at least one of the at least one character,
provide a character appearance feature, the appearance feature: (i) related to the appearance of one or more of the at least one character, and (ii) associated with selectable appearance options,
provide a character name feature, the character name feature: (i) related to the name of one or more of the at least one character, and (ii) associated with selectable name options, and
provide a character gender feature, the character gender feature: (i) related to the gender of one or more of the at least one character, and (ii) associated with selectable gender options, and
customize the book based on associating one or more of the at least one drawing with at least one of:
a selected appearance option,
at least one word including one of: a provided name and a selected name option,
at least one word including a pronoun consistent with a selected gender option, and
at least one word including a possessive adjective consistent with the selected gender option.

24. The processor program of claim 23, further comprising instructions to cause a processor to:
based on the request, provide a first book feature related to the reading level of the book and associated with selectable reading-level options.

25. The processor program of claim 24, further comprising instructions to cause a processor to:
based on a selected reading-level option, provide a second book feature related to the title of the book and associated with selectable title options, at least two of the title options being associated with unique sets of words and accompanying illustrations.

26. A method for redeeming a gift identifier, the method comprising:
receiving a gift identifier associated with a gift certificate and data identifying the entity who requested the gift certificate,
providing an option to send a message to the entity who requested the gift certificate associated with the received gift identifier, and
based on receiving a selection of the option, sending the message to the entity who requested the gift certificate.

27. The method of claim 26, wherein the gift identifier is generated based on one or more of a data compression scheme and a data encryption scheme of data associated with the entity who requested the gift certificate.

28. The method of claim 26, wherein the data identifying the entity who requested the gift certificate includes contact information for the entity.

29. The method of claim 28, wherein the contact information includes one or more of: an email address, a facsimile number, a postal mail address, and a telephone number.

30. The method of claim 26, wherein the data identifying the entity who requested the gift certificate includes a name of the entity who requested the gift certificate.

31. The method of claim 26, wherein receiving the gift identifier includes:
receiving the gift identifier via one or more of: a wired telecommunications network, a wireless telecommunications network, an email communication, a facsimile communication, a postal mail communication, and a telephone communication.

32. The method of claim 26, wherein the message includes one or more of: a video component and an audio component.

33. The method of claim 26, wherein providing the option includes:
providing the option without revealing at least one of the identity and contact information of the entity who requested the gift certificate associated with the received gift identifier.

34. The method of claim 26, wherein providing the option includes:
providing,
a first option for providing a pre-determined message to the entity who requested the gift certificate, and
a second option for providing a customized message to the entity who requested the gift certificate.

35. The method of claim 34, wherein the pre-determined message expresses gratitude to the entity who requested the gift certificate.

36. The method of claim 26, wherein sending the message to the entity includes:
identifying the entity based on comparing the received gift identifier with at least one previously stored gift identifier, each of the at least one previously stored gift identifier being associated with a gift certificate and data identifying the entity who requested the gift certificate.

37. The method of claim 36, wherein identifying the entity further includes:
identifying the entity based on a match between the received gift identifier and one of the at least one previously stored gift identifier.

38. The method of claim 26, wherein sending the message to the entity includes:
sending the message to the entity without revealing at least one of the identity and contact information of the entity.

39. A processor program for redeeming gift identifiers, the processor program being stored on a processor readable medium and including instructions to cause a processor to:
receive a gift identifier associated with a gift certificate and data identifying the entity who requested the gift certificate,
provide an option to send a message to the entity who requested the gift certificate associated with the received gift identifier, and
based on receiving a selection of the option, send the message to the entity who requested the gift certificate.

40. The processor program of claim 39, wherein the gift identifier is generated based on one or more of a data compression scheme and a data encryption scheme of data associated with the entity who requested the gift certificate.

41. The processor program of claim 39, wherein the data identifying the entity who requested the gift certificate includes contact information for the entity.

42. The processor program of claim 41, wherein the contact information includes one or more of: an email address, a facsimile number, a postal mail address, and a telephone number.

43. The processor program of claim 39, wherein the instructions to provide the option include instructions to:
provide the option without revealing at least one of the identity and contact information of the entity who requested the gift certificate associated with the received gift identifier.

44. The processor program of claim 34, wherein the instructions to send the message to the entity include instructions to:
identify the entity based on comparing the received gift identifier with at least one previously stored gift identifier, each of the at least one previously stored gift identifier being associated with a gift certificate and data identifying the entity who requested the gift certificate.

45. The processor program of claim 44, wherein the instructions to identify the entity further include instructions to:
identify the entity based on a match between the received gift identifier and one of the at least one previously stored gift identifier.

46. A method of redeeming gift certificates, the method comprising:
receiving a gift certificate identifier, the gift certificate identifier associated with a gift certificate,
providing an option to provide a message to the entity who requested the associated gift certificate, and
based on receiving a selection of the option and the gift identifier:
identifying the entity who requested the associated gift certificate, and
providing the message to the identified entity.

47. The method of claim 46, wherein identifying the entity includes:
identifying the entity based on comparing the received gift identifier with at least one previously stored gift identifier, each of the at least one previously stored gift identifier being associated with data identifying the entity who requested the gift certificate.

48. The method of claim 47, wherein identifying the entity further includes:
identifying the entity based on a match between the received gift identifier and one of the at least one previously stored gift identifiers.
